(19) United States
(12) Patent Application Publication
(10) Pub. No.: US 2001/0001392 A1
(43) Pub. Date: May 24, 2001

(54) Substrate treating method and apparatus

(75) Inventors: Sadao Hirae, Fushimi-ku (JP); Masanobu Sato, Fushimi-ku (JP); Shuichi Yasuda, Fushimi-ku (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 09/751,000

(22) Filed: Dec. 29, 2000

(30) Foreign Application Priority Data
Nov. 12, 1998 (JP) 10-321805 (P)

(51) Int. Cl. B08B 6/00

(52) U.S. Cl. 134/1.3; 156/345

(57) ABSTRACT

A substrate treating method for cleaning a substrate by supplying a cleaning solution thereto. The method comprises the steps of supplying the cleaning solution having ozone dissolved therein to the substrate, and irradiating the cleaning solution with ultraviolet light. By irradiating the cleaning solution having ozone dissolved therein with ultraviolet light, oxygen radicals are generated easily to increase the activity of the cleaning solution. Thus, a significantly improved cleaning capability is achieved even with low concentration ozone water. This method is applicable also to a piecemeal treatment for cleaning large substrates. Since the cleaning solution supplied to the substrate contains ozone in a low concentration, a filter and piping materials for supplying the cleaning solution need not have strong ozone resistance.

### BACKGROUND OF THE INVENTION

(1) Field of the Invention

The present invention relates to substrate treating methods and apparatus for treating semiconductor substrates, glass substrates for liquid crystal displays, glass substrates for photomasks, substrates for optical disks and the like (hereinafter referred to simply as substrates). Such treatment includes cleaning treatment carried out by supplying a cleaning solution to substrates, and film removing treatment carried out by supplying a treating solution to substrates to remove film coatings therefrom. More particularly, the invention relates to a cleaning treatment and film removing treatment performed by using a solution having ozone dissolved therein.

(2) Description of the Related Art

Conventional scrub cleaning is a typical, physical cleaning which can remove particles from surfaces of semiconductor substrates without using a chemical solution. Methods for separating particles from substrate surfaces include a “brush scrub method” in which a brush is placed in direct contact with a substrate surface spinning at high speed, a “jet scrub method” in which super pure water is jetted from a high-pressure jet nozzle to a substrate surface, an “ultrasonic scrub method” in which super pure water with ultrasonic wave applied thereto is supplied to a substrate surface to apply ultrasonic vibration thereto, and a “compound method” combining the above methods.

It has been pointed out recently that organisms adhere to substrates left in a cleanroom atmosphere, and become a factor to lower the dielectric withstand voltage of insulating film. The adhesion of organisms also lowers the “wettability” of substrates, and becomes a factor to hamper cleaning effect. Further, such organisms may undergo hydrolysis during a cleaning process to remain as particles on the substrate surface. These organisms may be removed relatively easily by using a mixed liquid of sulfuric acid and hydrogen peroxide solution. However, cleaning methods that avoid use of acids and alkalis as much as possible is desired from the viewpoints of waste treatment and environmental hazards resulting from a large consumption of acids.

One way of solving this problem is to remove organisms by exposure to ultraviolet light in the atmosphere. This technique uses ultraviolet light with a line spectrum (185 nm) emitted from a low-pressure mercury lamp having low-pressure mercury vapor enclosed in a high purity silica glass tube, or with a line spectrum (172 nm) emitted from an excimer lamp.

However, these lamps have the following limitations in use.

The low-pressure mercury lamp takes a long time to become operable after power is supplied. Thus, in many cases the lamp is continuously powered in use, and must therefore be changed frequently. The low-pressure mercury lamp using high purity quartz is expensive, and frequent changing inevitably brings about an increased maintenance cost.

The excimer lamp takes only a short time to become operable after power is supplied. This lamp may be powered only when necessary. The lamp may be changed less frequently to keep down maintenance cost. However, an apparatus itself that includes the excimer lamp is very expensive. In this sense, the excimer lamp has both merit and demerit in terms of cost.

Both lamps emit ultraviolet light in the atmosphere, and generate a large quantity of ozone, which requires safety measures to be taken, such as ventilation of a processing chamber and leak prevention. A large part of ultraviolet light emitted in the atmosphere is absorbed by oxygen present in the air before the ultraviolet light reaches the vicinity of a substrate surface. Thus, the lamps must be disposed as close to the substrate surface as possible. Ultraviolet light emitted from the excimer in particular has a 172 nm wavelength and is absorbed in a very large amount. To secure a sufficient effect, the excimer lamp must be disposed as close as about 2 to 3 mm to the substrate surface. The low-pressure mercury lamp, though not so close as the excimer lamp, needs to be disposed at a distance of about 30 mm to the substrate surface.

Thus, these lamps must be disposed close to the substrate surface in order to remove organisms effectively by means of ultraviolet light. Where used to aid in a cleaning treatment using a cleaning solution, the lamps must be located at a certain distance from the substrate to secure space for accommodating a brush and a cleaning solution supply nozzle, for example. To satisfy the two conflicting requirements, therefore, an ultraviolet irradiating chamber must be provided separately from a cleaning chamber, which requires extra space.

Then, what is in the spotlight today is use of a cleaning solution (so-called ozone water) having ozone gas dissolved in deionized water, which allows an organism removing operation to be carried out in one chamber. Ozone water is said to provide the higher cleaning effect the higher the concentration of ozone is in the water.

However, this conventional practice has the following drawbacks.

As noted above, ozone must be dissolved in a high concentration in order to produce an excellent cleaning effect. With existing dissolving methods, ozone can at best be dissolved at about 10-20 ppm in deionized water. Inventors herein have carried out cleaning operations to remove various types of organisms by using ozone water with ozone concentrations in the above-noted range and thereabout. It has been found that the cleaning effect is insufficient.

Specifically, substrates deliberately coated with HMDS (hexamethyldisilazane) under reduced pressure were used as test samples. After cleaning treatments, contact angles on the substrate surfaces were measured to determine clean levels. HMDS coating is a typical example of organisms that adhere to substrates in a cleanroom. These organisms have a characteristic that their contact angle to water is readily variable with an increase in the quantity of adhesion, and therefore are well suited as an organism removal indicator. FIG. 1 is a graph showing a relationship between puddling time and contact angle obtained by supplying the above ozone water to the test samples. For comparison purposes, the figure shows also a relationship between irradiation time and contact angle obtained by irradiating substrate surfaces with the ultraviolet light of 172 nm emitted from an excimer lamp.

As seen from this graph, ozone water with ozone concentrations in the above-noted range fails to produce a satisfactory cleaning effect, and the results are far inferior to those of cleaning treatment done with only the excimer lamp. With such a cleaning effect, ozone water may be used only in batch cleaning treatment in that a long treating time may be set per substrate since a plurality of substrates are treated at a time. With substrates increasing in diameter, a piecemeal or single-substrate cleaning process is in reality required to treat each substrate in a reduced time. In the actual situation illustrated in FIG. 1, satisfactory cleaning results cannot be obtained in such a short processing time.

Apart from the cleaning treatment, the same problem occurs with treatment for removing photoresist film from substrates by supplying ozone water thereto. A satisfactory film removing performance cannot be expected for the same reason noted above.

### SUMMARY OF THE INVENTION

The present invention has been made having regard to the state of the art noted above, and its object is to provide a substrate treating method and apparatus for cleaning substrates or removing film therefrom with significantly improved capabilities by increasing the activity of a cleaning or treating solution.

The above object is fulfilled, according to the present invention, by a substrate treating method for cleaning a substrate by supplying a cleaning solution thereto, comprising the steps of supplying the cleaning solution having ozone dissolved therein to the substrate, and irradiating the cleaning solution with ultraviolet light.

It has been known for a relatively long time that a cleaning solution with ozone dissolved therein has a good cleaning effect. The cleaning effect is produced chiefly by immersing whole substrates in ozone water stored in a cleaning tank, With increases in size of substrates, such treatment must be done in a short time in cleaning one substrate after another. In this sense, a higher cleaning capability is required for use in such piecemeal treatment than in batch treatment.

However, ozone water is currently obtained by dissolving ozone gas directly in deionized water or by using positively charged water (or anode water) resulting from an electrolysis. Thus, ozone is dissolved in a cleaning solution in a concentration of about 10 ppm at most. Future progress in the ozone dissolving technique may realize a greatly increased concentration, but then sufficient ion resistance will be required for a filter and piping materials that transmit the cleaning solution. Inventors have invented a technique in which a cleaning solution having ozone dissolved in a minimum concentration is supplied to a substrate, and its cleaning effect is increased by an auxiliary device.

It is considered that insufficient cleaning results are obtained when an attempt is made to remove organisms adhering to the substrate only with ozone through a reaction in air, and oxygen radicals must contribute to the reaction. This is true of the reaction within the cleaning solution also; oxygen radicals play a predominant role in the reaction. To describe a process of generating the oxygen radical, the oxygen molecule is excited as follows according to the wavelengths of light, and high energy is required to acquire the oxygen radical (O(³p)).

hv

O₂→O(³p)+O(³p)λ<242.4 nm (5.16 eV)

O₂→O(³p)+O(¹D)λ<175.0 nm (7.08 eV)

O₂→O(³p)+O(¹S)λ<133.2 nm (9.30 eV)

On the other hand, ozone is excited as follows, but the oxygen radical may be obtained with low energy.

O₃→O(³p)+O₂λ<300.0 nm (4.13 eV)

Thus, oxygen radicals may be generated easily by supplying a cleaning solution having ozone dissolved in a low concentration therein to a substrate, and irradiating the cleaning solution with ultraviolet light (λ=1 to 400 nm). The oxygen radicals react with water to generate OH radicals, thereby increasing the activity of the cleaning solution.

In this way, oxygen radicals are generated easily by irradiating the cleaning solution having ozone dissolved therein with ultraviolet light. The oxygen radicals react with water to generate OH radicals, thereby increasing the activity of the cleaning solution. By irradiating the cleaning solution having ozone dissolved therein with ultraviolet light, oxygen radicals are generated easily to increase the activity of the cleaning solution. Thus, a significantly improved cleaning capability is achieved even with low concentration ozone water. This method is applicable also to a piecemeal or single-substrate process for treating large substrates. Since the cleaning solution supplied to the substrate contains ozone in a low concentration, a filter and piping materials for supplying the cleaning solution need not have strong ozone resistance.

In another aspect of the invention, a substrate treating method for cleaning a substrate by supplying a cleaning solution thereto, comprises the steps of irradiating the cleaning solution having ozone dissolved therein with ultraviolet light, and supplying the cleaning solution to the substrate.

By irradiating the cleaning solution having ozone dissolved therein with ultraviolet light before the cleaning solution is supplied to the substrate, oxygen radicals may be generated easily as in the foregoing method. The oxygen radicals react with water to generate OH radicals, thereby increasing the activity of the cleaning solution.

Preferably, the ultraviolet light has a wavelength in a range of 242.4 to 300 nm.

The oxygen molecule is excited according to the wavelengths of light as described hereinbefore, and therefore high energy is required to acquire the oxygen radical. Ozone is excited as described, and the oxygen radical may be generated even with low energy. That is, when ultraviolet light in a wavelength range of 242.4 nm<λ<300.0 nm is emitted in the atmosphere, oxygen is not decomposed but OH radicals are generated by oxygen radicals excited by decomposition of ozone. The organisms adhering to the substrate are oxidized into water and carbon dioxide. Thus, by irradiating the cleaning solution having ozone dissolved therein with the ultraviolet light in the above wavelength range, ozone is readily decomposed into oxygen radicals to increase the activity of the cleaning solution.

FIG. 8 is a graph showing the transmittance of ultraviolet light of λ=254 nm through various aqueous solutions. It will be seen that a very large part of ultraviolet light around this wavelength penetrates air and distilled water without being absorbed. Since the cleaning solution forms a puddle of about 1 mm on the substrate surface, ultraviolet light in the above wavelength range is hardly absorbed except by ozone. Further, when ultraviolet light within the above wavelength range is emitted in the atmosphere, ozone is never generated by oxygen decomposition.

It is possible to generate oxygen radicals by emitting ultraviolet light having wavelengths at 242.4 nm and less. However, such ultraviolet light must be generated by using a low-pressure mercury lamp or excimer lamp formed of quartz which has inconveniences of being high cost in construction and having to be disposed close to the substrate surface because of the question of absorption. Ultraviolet light within the above wavelength range can be generated by a low-priced ozoneless low-pressure mercury lamp. This lamp is inexpensive because it may use quartz of lower purity than a tube material for an ozone generating lamp.

Since ultraviolet light in the wavelength range of 242.4 to 300 nm is hardly absorbed by deionized water or air, an ultra-violet light emitting device may have a large spacing from the substrate surface. This allows a cleaning brush or brushes, for example, to be used in the same chamber where ultraviolet light irradiation is carried out. Since ozone is not generated at all, little consideration is required as to ventilation and the like, and the low-priced ozoneless UV lamp may used to emit ultraviolet light.

It is preferred that the cleaning solution has a base added thereto.

By adding a base to the cleaning solution, particles of positive charge separated from the substrate through the cleaning treatment may be negatively charged as is the substrate, to prevent the particles from adhering to the substrate again by static electricity. Consequently, the substrate may be cleaned with increased effect.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a graph showing a relationship between UV irradiating time/ozone water puddling time and contact angle according to conventional practice;

FIG. 2 is a block diagram showing an outline of a substrate treating apparatus in a first embodiment;

FIG. 3 is a view illustrating a cleaning process;

FIG. 4 is a view illustrating a drying process;

FIG. 5 is a block diagram showing an outline of a substrate treating apparatus in a second embodiment;

FIG. 6 is a view illustrating a photoresist film removing process;

FIG. 7 is a view illustrating a drying process; and

FIG. 8 is a graph showing the transmittance of ultraviolet light through various media.

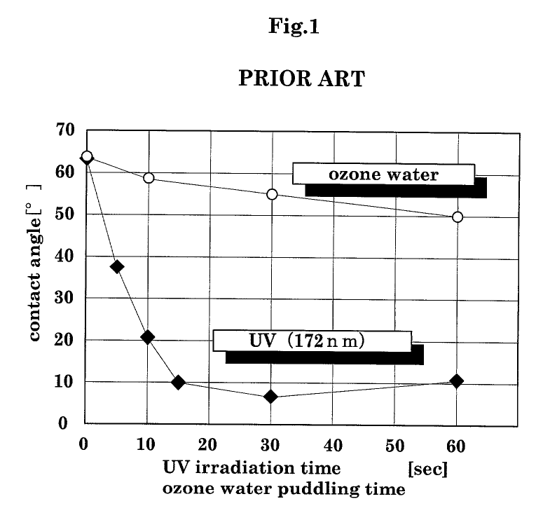

### DESCRIPTION OF THE PREFERRED EMBODIMENTS

Preferred embodiments of the present invention will be described in detail hereinafter with reference to the drawings.

<First Embodiment>

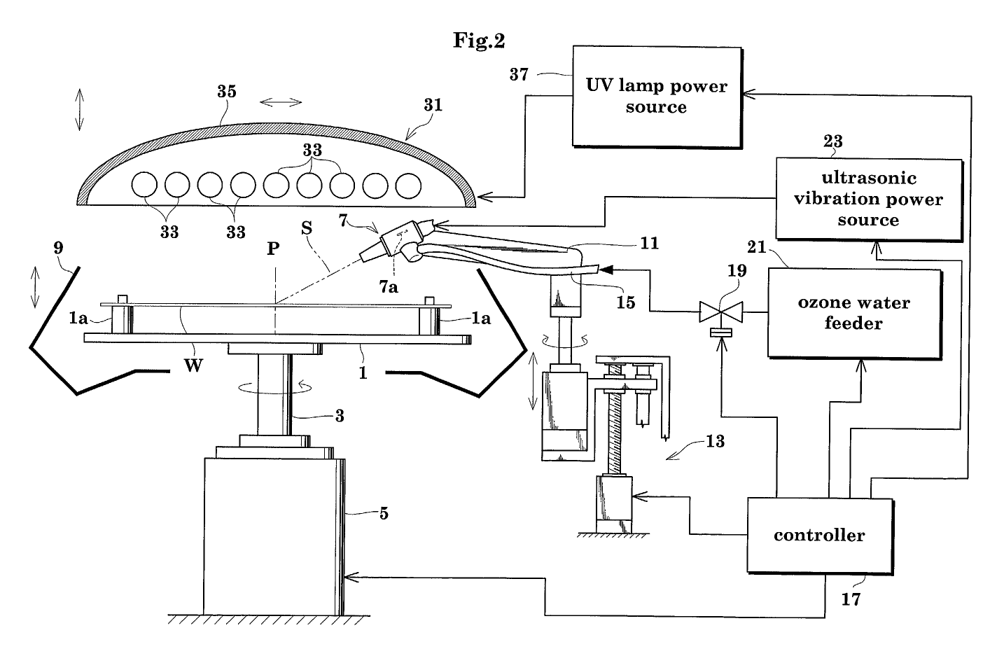

FIG. 2 is a block diagram showing an outline of a substrate treating apparatus in a first embodiment.

A disk-shaped spin chuck 1 having six cylindrical support pins 1a erected thereon is spun by an electric motor 5 through a rotary shaft 3 connected to the bottom of spin chuck 1. With a spin of spin chuck 1, a wafer W supported at edges thereof by the support pins 1a spins in a horizontal plane about a spin center P.

The spin chuck 1 is surrounded by a scatter preventive cup 9 for preventing scattering of a cleaning liquid or solution S discharged from an ultrasonic nozzle 7. The scatter preventive cup 9 is moved vertically relative to the spin chuck 1 as indicated by an arrow in FIG. 2, when a wafer W to be cleaned is placed on the spin chuck 1 and when a transport device not shown receives a cleaned wafer W from the spin chuck 1.

The spin chuck 1, rotary shaft 3 and electric motor 5 constitute the support means of the present invention.

The nozzle 7 is supported in an inclined posture by a support arm 11, with a discharge opening pointed to the spin center P. The nozzle 7 is vertically movable and swingable, along with the support arm 11, by a drive mechanism 13 as indicated by arrows in FIG. 2.

The nozzle 7 is swingable between a cleaning position above the wafer W and a standby position retracted sideways from the wafer W and scatter preventive cup 9. The nozzle 7 has a pipe 15 connected to a barrel portion thereof. The pipe 15 extends from an ozone water feeder 21 through a control valve 19 operable under control of a controller 17. Thus, the ozone water feeder 21 supplies the nozzle 7 with ozone water having ozone dissolved in deionized water to act as the cleaning solution.

The cleaning solution has ozone dissolved in a low concentration in the order of 10 ppm.

As the cleaning solution is supplied to the nozzle 7, an oscillator 7a applies ultrasonic vibration (e.g. 1.5 MHz) to the cleaning solution. An ultrasonic vibration power source 23 applies a high frequency voltage corresponding to a natural frequency thereof to the oscillator 7a.

The nozzle 7, pipe 15, control valve 19 and ozone water feeder 21 constitute the cleaning solution supply means of this invention.

A movable TV irradiating unit 31 (ultraviolet emitting device) is disposed in an irradiating position above the scatter preventive cup 9 for emitting ultraviolet light toward the wafer W. The UV irradiating unit 31 is movable between the irradiating position shown in FIG. 2 and a standby position (not shown) retracted sideways from the scatter preventive cup 9,

The UV irradiating unit 31 includes a plurality of ozoneless UV lamps 33 arranged on a reflector 35 for emitting ultraviolet light toward the wafer W. The ozoneless UV lamps 33 are powered by an ozoneless UV lamp power source 37 to emit ultraviolet light. The ultraviolet light emitted from the ozoneless NV lamps 33, preferably, is in a wavelength range of 242.4 nm<λ<300.0 nm, so that oxygen radicals may be generate from ozone with low energy. The ozoneless UV lamps 33 in this embodiment emit light of λ=254 nm, for example.

The electric motor 5, drive mechanism 13, control valve 19, ozone water feeder 21, ultrasonic vibration power source 23, ozoneless UV lamp power source 37 noted above are controlled en bloc by the controller 17.

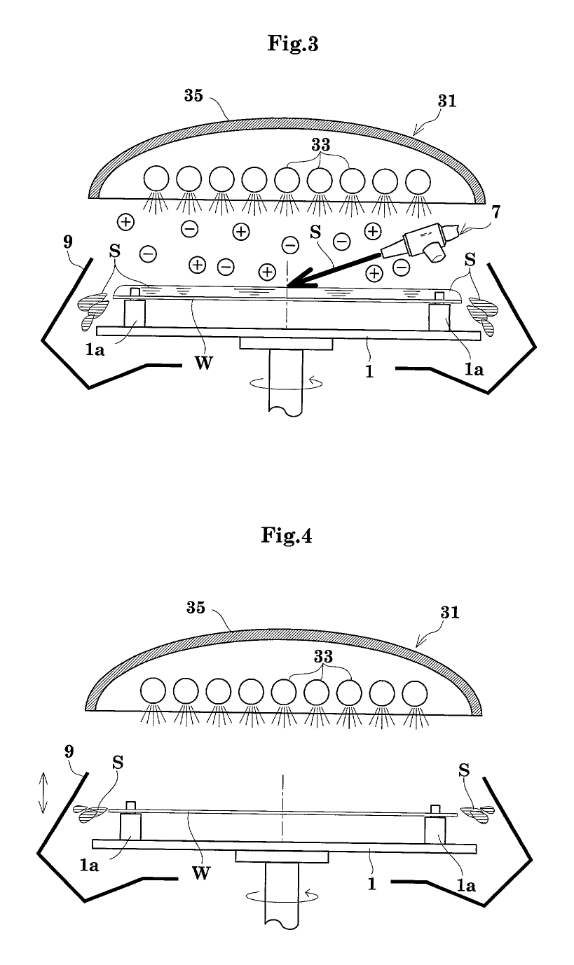

Next, treating processes performed by the above substrate treating apparatus will be described with reference to FIGS. 3 and 4.

<Cleaning Process>

First, the scatter preventive cup 9 is lowered relative to the spin chuck 1, and a wafer W is placed on the spin chuck 1. The scatter preventive cup 9 is raised, and the nozzle 7 is moved to the cleaning position. The UV irradiating unit 31 is moved to the irradiating position above the wafer W to start irradiating the wafer W with ultraviolet light.

Next, the cleaning solution S is supplied from the nozzle 7 to the wafer W spinning at a fixed low speed, to form a puddle of cleaning solution S over the upper surface of wafer W (FIG. 3).

At this time, the cleaning solution S containing ozone is irradiated with ultraviolet light to become excited into a state “O₃→O(³p)+O₂”. Oxygen radicals are acquired with low energy in this way. Thus, oxygen radicals may be generated easily, which react with water to generate OH radicals. The activity of the cleaning solution is thereby increased to realize a significantly improved cleaning capability. It will be noted also that positive and negative ions are generated in the atmosphere around the wafer W.

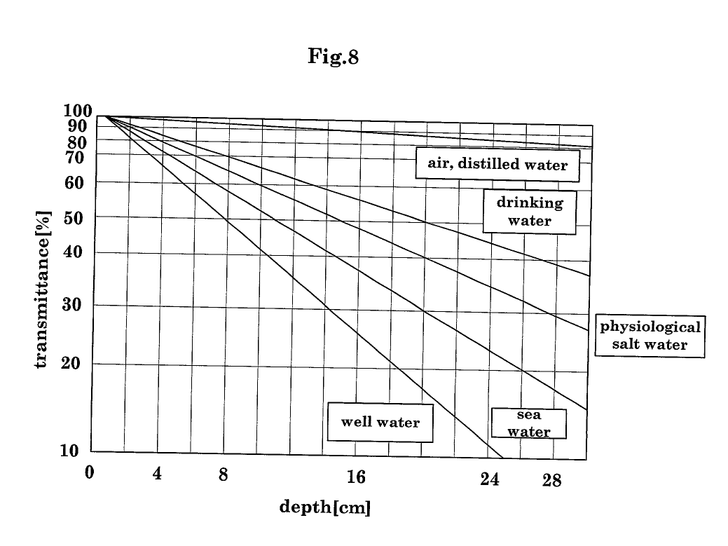

The ultraviolet light of this wavelength, as shown in FIG. 8, penetrates water and air with only minor fractions thereof absorbed. This feature allows the UV irradiating unit 31 to have a large distance from the surface of wafer W. There is no need to dispose the ultraviolet light irradiating device close to the substrate as is the case with the conventional construction. The nozzle 7 may be used simultaneously with the ultraviolet irradiation in one treating chamber to realize an efficient cleaning process.

Since ozone is not generated at all, little consideration is required as to ventilation and the like, and the low-priced ozoneless UV lamps may serve the purpose. Consequently, the apparatus may be constructed simply and at low cost.

<Drying Process>

After the cleaning process in which the puddled state noted above is maintained for a fixed time, the cleaning solution is stopped and the nozzle 7 is moved to the standby position. At the same time, a spin drying process is started in which the wafer W is spun at high speed to scatter the cleaning solution S forming the puddle to the ambient (FIG. 4).

The ultraviolet irradiation may be continued during the drying process also.

The circuit elements formed on the surface of wafer W could fail to perform intended functions when mobile ions such as sodium ions are present inside the insulating film on the surface of wafer W. By continuing the ultraviolet irradiation during the drying process, negative ions may be generated in the wafer W to neutralize the insulating film. This measure will stabilize the operation of the elements.

The ultraviolet irradiation may be stopped during the drying process. Further, the ultraviolet irradiation may be effected only for a predetermined time, rather than throughout the cleaning process.

The first embodiment has been described, taking the substrate spin cleaning apparatus for example. The present invention is applicable also to an apparatus for cleaning substrates without spinning the latter. It is not essential to apply ultrasonic vibration to the cleaning solution, but the cleaning solution may simply be supplied from the nozzle.

<Second Embodiment>

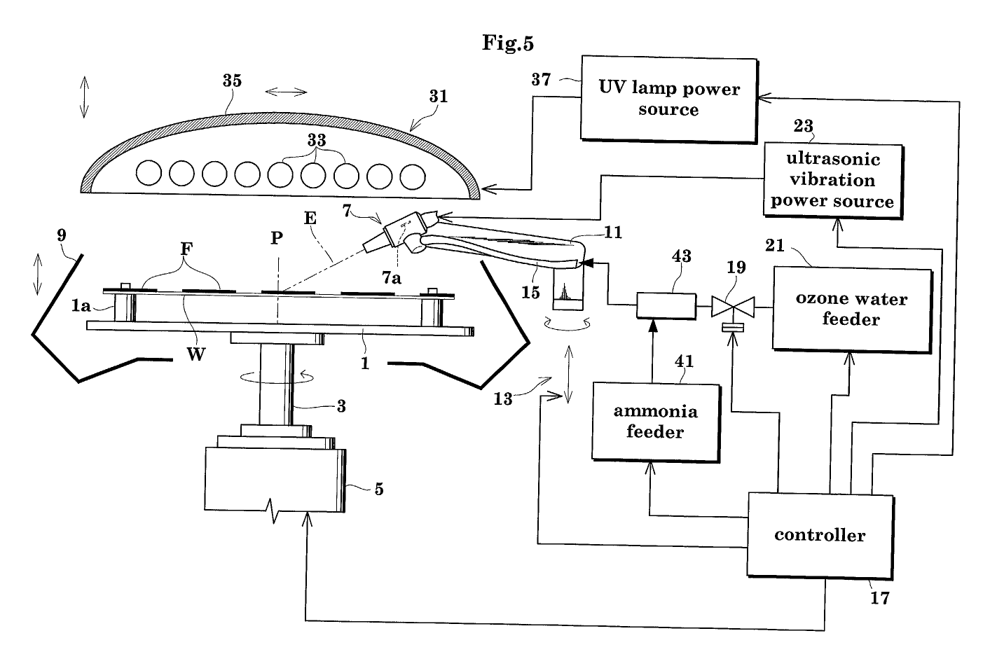

FIG. 5 is a block diagram showing an outline of a substrate treating apparatus in a second embodiment.

The first embodiment has been described, taking the substrate treating apparatus for cleaning substrates for example. In this embodiment, the substrate treating apparatus is used to remove film from substrates. The film to be removed herein is photoresist film which is one example of films coating the substrates. Parts identical to those of the first embodiment are shown with the same reference numbers, and will not particularly be described again.

The pipe 15 connected to the nozzle 7 transmits ozone water having ozone dissolved in deionized water and acting as a treating solution, from the ozone water feeder 21 through the control valve 19 operable under control of the controller 17. The pipe 15 has a mixing valve 43 disposed thereon downstream of the control valve 19 for mixing ammonia supplied in a predetermined quantity from an ammonia feeder 41 into the ozone water flowing through the pipe 15. Ultrasonic vibration is applied to the ozone water having ammonia added thereto. In this state, the water is supplied as a treating solution E from the nozzle 7 to a wafer W having photoresist film F formed on the surface thereof.

While ammonia is added to the ozone water in this embodiment, a different base may be added thereto.

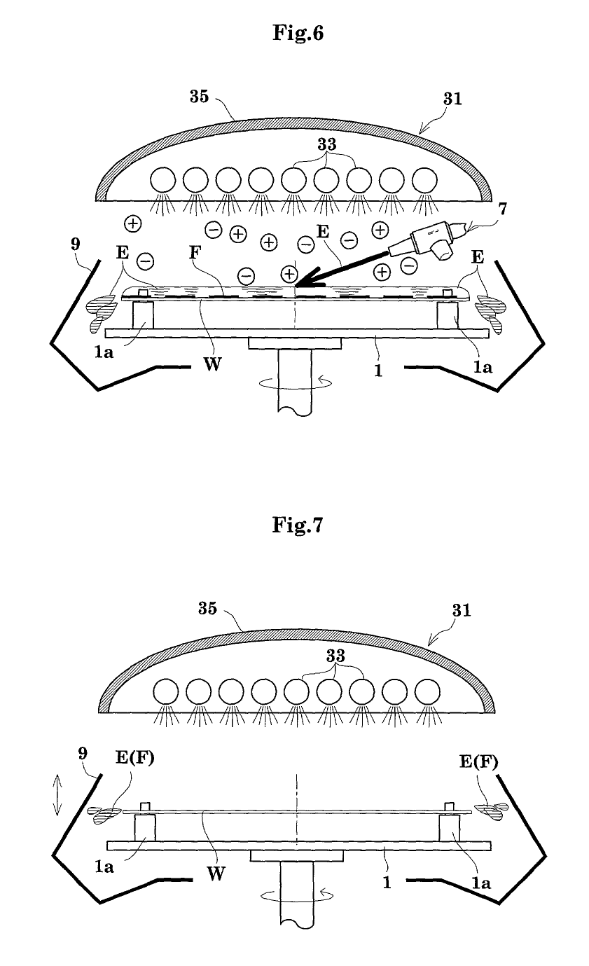

Next, photoresist removing processes performed by the above substrate treating apparatus will be described with reference to FIGS. 6 and 7.

<Cleaning Process>

After a wafer W with photoresist film F formed thereon is placed on the spin chuck 1, the nozzle 7 is moved to the cleaning position. The UV irradiating unit 31 is moved to the position above the wafer W to start irradiating the wafer W with ultraviolet light. The treating solution E is supplied from the nozzle 7 to the wafer W spinning at a fixed low speed, to form a puddle of treating solution E over the upper surface of wafer W (FIG. 6).

At this time, the treating solution E containing ozone is irradiated with ultraviolet light, whereby oxygen radicals are acquired with low energy, as described hereinbefore. Thus, oxygen radicals may be generated easily, which react with water to generate OH radicals. The activity of the treating solution is thereby increased to realize a significantly improved capability for removing photoresist film F.

The ultraviolet light of the wavelength emitted penetrates water and air with only minor fractions thereof absorbed. Thus, as in the first embodiment, the nozzle 7 may be used simultaneously with the ultraviolet irradiation in one treating chamber to realize an efficient cleaning process. Since ozone is not generated at all, little consideration is required as to ventilation and the like, and low-priced ozoneless UV lamps may serve the purpose.

This apparatus, with use as the treating solution E of ozone water having ammonia, i.e. a base, added thereto, provides the following additional advantage.

By adding ammonia which is a base to the ozone water, the PH of the treating solution may be controlled. Generally, particles of photoresist film F and alumina separated from the wafer W tend to be positively charged, and the wafer W tends to have a negative surface potential. Consequently, the photoresist film F and the like separated will adhere to the surface of wafer W by static electricity. However, by adding ammonia, the photoresist film F and the like separated may be negatively charged as is the wafer W. This results in a repulsion therebetween which prevents the photoresist film F and the like from electrostatically adhering to the wafer W again.

<Drying Process>

After the film removing process in which the puddled state noted above is maintained for a fixed time, the treating solution E is stopped and the nozzle 7 is moved to the standby position. At the same time, a spin drying process is started in which the wafer W is spun at high speed to scatter the treating solution E with photoresist film F dissolved therein to the ambient (FIG. 7).

The ultraviolet irradiation may be continued during the drying process also.

While, in the second embodiment, ammonia which is a base is added to the treating solution having ozone dissolved therein, re-adhesion of film and the like may be prevented by adding a surface active agent in place of ammonia. In the apparatus described above, the mixing valve 43 is used to mix ammonia into the ozone water. Instead of mixing ammonia midway, ozone water to which ammonia is added beforehand may be supplied from the ozone water feeder 21.

Further, ammonia may be added also to the ozone water in the substrate cleaning apparatus in the first embodiment. The substrate treating apparatus for removing film in the second embodiment may of course perform the treatment by using ozone water without ammonia added thereto.

<Other Embodiments>

In each of the foregoing embodiments, ultraviolet light is emitted from the ozoneless UV lamps 33 directly toward the wafer W. The pipe 15 may include UV lamps (not shown) arranged adjacent the nozzle 7 shown in FIGS. 2 and 5 for irradiating the cleaning or treating solution with ultraviolet light before being supplied to the substrate. In this case also, oxygen radicals are acquired with low energy to generate OH radicals, thereby increasing the activity of the cleaning or treating solution.

In the above description, treatment is carried out only by supplying the cleaning solution S or treating solution E from the nozzle 7. A brush or brushes may additionally be used to act on the substrate surface to promote the cleaning or film removing performance.

The present invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating method for cleaning a substrate by supplying a cleaning solution thereto, comprising the steps of:
supplying said cleaning solution having ozone dissolved therein to said substrate; and
irradiating said cleaning solution with ultraviolet light.

2. A substrate treating method for cleaning a substrate by supplying a cleaning solution thereto, comprising the steps of:
irradiating said cleaning solution having ozone dissolved therein with ultraviolet light; and
supplying said cleaning solution to said substrate.

3. A method as defined in claim 1, wherein said ultraviolet light has a wavelength in a range of 242.4 to 300 nm.

4. A method as defined in claim 2, wherein said ultraviolet light has a wavelength in a range of 242.4 to 300 nm.

5. A method as defined in claim 1, wherein said cleaning solution has a base added thereto.

6. A method as defined in claim 2, wherein said cleaning solution has a base added thereto.

7. A method as defined in claim 3, wherein said cleaning solution has a base added thereto.

8. A method as defined in claim 4, wherein said cleaning solution has a base added thereto.

9. A substrate treating apparatus comprising:
support means for supporting a substrate;
cleaning solution supply means for supplying a cleaning solution having ozone dissolved therein to said substrate; and
ultraviolet emitting means for emitting ultraviolet light to said substrate;
wherein, during a cleaning process in which said cleaning solution is supplied from said cleaning solution supply means to said substrate supported by said support means, said ultraviolet emitting means emits ultraviolet light to said cleaning solution supplied to said substrate.

10. An apparatus as defined in claim 9, wherein the ultraviolet light emitted from said ultraviolet light emitting means has a wavelength in a range of 242.4 to 300 nm.

11. An apparatus as defined in claim 9, wherein said cleaning solution has a base added thereto.

12. An apparatus as defined in claim 10, wherein said cleaning solution has a base added thereto.

13. A substrate treating apparatus comprising:
support means for supporting a substrate;
ultraviolet emitting means for emitting ultraviolet light to a cleaning solution having ozone dissolved therein before said cleaning solution is supplied to said substrate; and
cleaning solution supply means for supplying said cleaning solution irradiated with ultraviolet light to said substrate supported by said support means.

14. An apparatus as defined in claim 13, wherein the ultraviolet light emitted from said ultraviolet light emitting means has a wavelength in a range of 242.4 to 300 nm.

15. An apparatus as defined in claim 13, wherein said cleaning solution has a base added thereto.

16. An apparatus as defined in claim 14, wherein said cleaning solution has a base added thereto.

17. A substrate treating method for removing film from a substrate by supplying a treating solution thereto, comprising the steps of:
supplying said treating solution having ozone dissolved therein to said substrate; and
irradiating said treating solution with ultraviolet light.

18. A substrate treating method for removing film from a substrate by supplying a treating solution thereto, comprising the steps of:
irradiating said treating solution having ozone dissolved therein with ultraviolet light; and
supplying said treating solution to said substrate.

19. A method as defined in claim 17, wherein said ultraviolet light has a wavelength in a range of 242.4 to 300 nm.

20. A method as defined in claim 18, wherein said ultraviolet light has a wavelength in a range of 242.4 to 300 nm.

21. A method as defined in claim 17, wherein said treating solution has a base added thereto.

22. A method as defined in claim 18, wherein said treating solution has a base added thereto.

23. A method as defined in claim 19, wherein said treating solution has a base added thereto.

24. A method as defined in claim 20, wherein said treating solution has a base added thereto.

25. A substrate treating apparatus for removing film from a substrate by supplying a treating solution thereto, comprising:
support means for supporting said substrate;
treating solution supply means for supplying said treating solution having ozone dissolved therein to said substrate; and
ultraviolet emitting means for emitting ultraviolet light to said substrate;
wherein, during a film removing process in which said treating solution is supplied from said treating solution supply means to said substrate supported by said support means, said ultraviolet emitting means emits ultraviolet light to said treating solution supplied to said substrate.

26. An apparatus as defined in claim 25, wherein the ultraviolet light emitted from said ultraviolet light emitting means has a wavelength in a range of 242.4 to 300 nm.

27. An apparatus as defined in claim 25, wherein said treating solution has a base added thereto.

28. An apparatus as defined in claim 26, wherein said treating solution has a base added thereto.

29. A substrate treating apparatus for removing film from a substrate by supplying a treating solution thereto, comprising:
support means for supporting said substrate;
ultraviolet emitting means for emitting ultraviolet light to said treating solution having ozone dissolved therein, before said treating solution is supplied to said substrate; and
treating solution supply means for supplying said treating solution irradiated with ultraviolet light to said substrate supported by said support means.

30. An apparatus as defined in claim 29, wherein the ultraviolet light emitted from said ultraviolet light emitting means has a wavelength in a range of 242.4 to 300 nm.

31. An apparatus as defined in claim 29, wherein said treating solution has a base added thereto.

32. An apparatus as defined in claim 30, wherein said treating solution has a base added thereto.
